(19) United States
(12) Patent Application Publication
(10) Pub. No.: US 2023/0108398 A1
(43) Pub. Date: Apr. 6, 2023

(54) MOTOR, POSITIONING DEVICE, AND POSITIONING METHOD

(71) Applicant: Nidec Corporation, Kyoto (JP)

(72) Inventors: Hiroshi SAMBUICHI, Dalian (CN); Ting HUANG, Dalian (CN); Zhiming ZHAO, Dalian (CN); Shicheng SUN, Dalian (CN)

(21) Appl. No.: 17/952,367

(22) Filed: Sep. 26, 2022

(30) Foreign Application Priority Data
Sep. 30, 2021 (CN) 202111162495

(51) Int. Cl. H02K 5/22; H02K 11/33

(52) U.S. Cl. CPC H02K 5/225; H02K 11/33; H02K 2203/09

(57) ABSTRACT

A motor includes a stator, a rotor, a bus bar assembly, and a housing. The bus bar assembly includes an interface portion in which the power supply connection terminal is provided. The interface portion includes a first positioning portion. The housing includes a second positioning portion. The first and second positioning portions are positioned relative to each other by being respectively provided in predetermined relative positions. As a result, the relative position between the housing and the bus bar assembly can be accurately positioned, and the assembly accuracy of the motor can be enhanced.

### CROSS-REFERENCE TO RELATED APPLICATIONS

The present application claims priority under 35 U.S.C. §119 to CN Patent Application No. 202111162495, filed on Sep. 30, 2021, the entire contents of which are hereby incorporated herein by reference.

### 1. FIELD OF THE INVENTION

The disclosure of the present application relates to a motor, a positioning device, and a positioning method.

### 2. BACKGROUND

A conventional motor includes members such as a rotor, a stator, a housing, and a bus bar unit. When these members are assembled, it is necessary to perform mutual positioning between the members.

Conventionally, assembly is generally performed according to the following procedure. First, the foot portion of the bus bar unit is inserted into the insulating component of the stator to roughly position the bus bar unit and the stator. Next, the assembled bus bar unit and stator are then inserted into the housing of the motor. In this step, mutual positioning between the stator and the housing is performed by determining mutual positions between the stator and the housing using a positioning jig. Accordingly, mutual positioning between the bus bar unit and the housing is performed.

The foregoing description of the technical background is merely provided to facilitate clear and sufficient description of the technical solutions of the disclosure of the present application, and to facilitate understanding of those skilled in the art. These solutions should not be considered to be known merely because they are described in the background of the disclosure of the present application.

Since the relative position between the bus bar unit and the housing is indirectly realized by positioning between the bus bar unit and the stator and positioning between the stator and the housing, it is difficult to increase the accuracy of the relative position between the bus bar unit and the housing.

### SUMMARY

A motor according to one example embodiment of the present disclosure includes a motor with a stator, a rotor rotatable relative to the stator about a central axis extending along an axial direction, a bus bar assembly on one side in the axial direction of the stator, and a housing that accommodates the stator, the rotor, and the bus bar assembly. The bus bar assembly includes an interface portion in which a power supply connection terminal is provided. The interface portion includes a first positioning portion to position the bus bar assembly with respect to other portions of the motor. The housing includes a second positioning portion to position the housing with respect to other portions of the motor. The first positioning portion and the second positioning portion are positioned relative to each other by being respectively provided in predetermined relative positions.

According to one example embodiment of the present disclosure, there is provided a positioning device to assemble a motor, the positioning device including a first positioning jig and a second positioning jig. The motor includes a stator, a rotor rotatable relative to the stator about a central axis extending along an axial direction, a bus bar assembly on one side in the axial direction of the stator, and a housing that accommodates the stator, the rotor, and the bus bar assembly. The bus bar assembly includes an interface portion in which a power supply connection terminal is provided. The interface portion includes a first positioning portion to position the bus bar assembly with respect to other portions of the motor. The housing includes a second positioning portion to position the housing with respect to other portions of the motor. The first positioning jig includes a third positioning portion provided in an interface portion to make contact with the first positioning portion of the bus bar assembly and to support the second positioning portion. The third positioning portion and the second positioning jig are provided in predetermined relative positions to each other during positioning.

According to one example embodiment of the disclosure of the present disclosure, there is provided a positioning method to position a motor with a positioning jig. The motor includes a stator, a rotor rotatable relative to the stator about a central axis extending along an axial direction, a bus bar assembly provided on one side in the axial direction of the stator, and a housing that accommodates the stator, the rotor, and the bus bar assembly. The bus bar assembly includes an interface portion in which a power supply connection terminal is provided. The interface portion includes a first positioning portion used to position the bus bar assembly with respect to other portions of the motor. The housing includes a second positioning portion to position the housing with respect to other portions of the motor. The positioning jig includes a first positioning jig and a second positioning jig. The first positioning jig includes a third positioning portion. The method includes bringing the third positioning portion into contact with the first positioning portion of the interface portion, supporting the second positioning portion with the second positioning jig, and positioning the first positioning portion and the second positioning portion at predetermined relative positions.

With reference to the following description and drawings, specific example embodiments of the disclosure of the present application are disclosed in detail, and examples in which the principles of the disclosure of the present application can be adopted are clearly shown. The scope of the claims includes many changes, modifications, and equivalents.

Features disclosed in one example embodiment may be used in the same or similar other example embodiments, combined with features in other example embodiments, or substituted for features in other example embodiments.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a top view of a motor according to a first example embodiment of the disclosure of the present application.

FIG. 2 is a perspective view illustrating a step of assembling the motor according to the first example embodiment of the disclosure of the present application.

FIG. 3 is a perspective view of a motor according to the first example embodiment of the disclosure of the present application.

FIG. 4 is a schematic view of a second positioning jig in a positioning device according to a second example embodiment of the disclosure of the present application.

FIG. 5 is a flowchart of a positioning method according to a third example embodiment of the disclosure of the present application.

### DETAILED DESCRIPTION

Features and other features of the disclosure of the present application will become clear through the following specification with reference to the drawings. In the specification and drawings, specific example embodiments in which some example embodiments of the disclosure of the present application can be adopted are specifically disclosed. The disclosure of the present application is not limited to the example embodiments disclosed in the specification. The disclosure of the present application includes all modifications, variations, and equivalents falling within the scope of the appended claims.

In each of the drawings, since each structural element has a size that can be identified on the drawings, the scale may be different for each structural element. The disclosure of the present application is not limited to the number of structural elements, the shape of the structural elements, the ratio of the sizes of the structural elements, and the relative positional relationship of the structural elements described in the drawings.

In the example embodiments of the disclosure of the present application, the terms “first”, “second”, and the like are used as designations for distinguishing different elements, but do not represent a spatial arrangement, a temporal order, or the like of these elements. These elements are not limited by terms such as “first” and “second”. The term “and/or” includes any one and all combinations of one or more of the associated listed terms. The terms “including”, “comprising”, “having”, and the like refer to the presence of stated features, elements, parts, or assemblies, but do not preclude the presence or addition of one or more other features, elements, parts, or assemblies.

In the example embodiments of the disclosure of the present application, the singular forms “one”, “the”, and the like include plural forms, and should be understood in a broad sense as “one kind” or “one type”, and are not limited to the meaning of “one”. The term “the” also includes the singular and the plural, unless the context clearly dictates otherwise. Also, unless explicitly stated otherwise front and back, the term “based on” should be understood as “based at least in part on ...”.

In the example embodiment of the disclosure of the present application, a direction extending along or parallel to the central axis OO' of the motor is referred to as an “axial direction”, a radial direction centered on the central axis OO' is referred to as a “radial direction”, and a direction around the central axis OO' is referred to as a “circumferential direction”. The definitions in the present specification for the respective directions are merely for convenience of description of the example embodiments of the disclosure of the present application, and do not limit directions at the time of use and manufacture of the motor and the like.

A first example embodiment of the disclosure of the present application provides a motor.

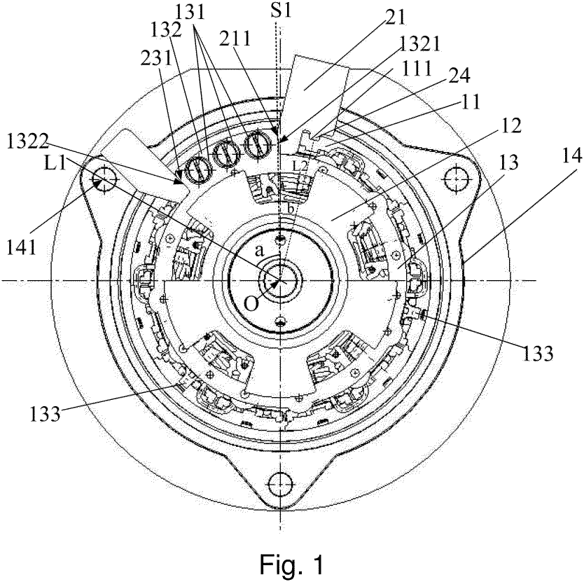

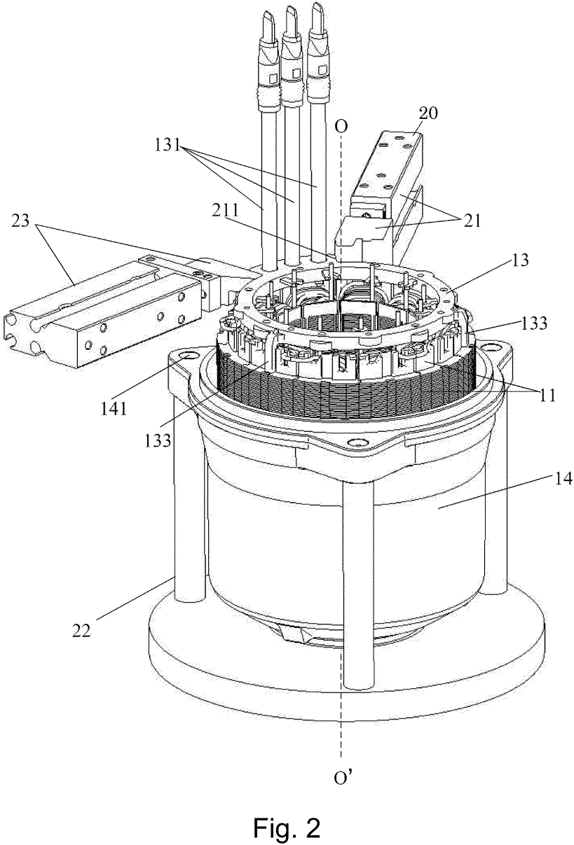

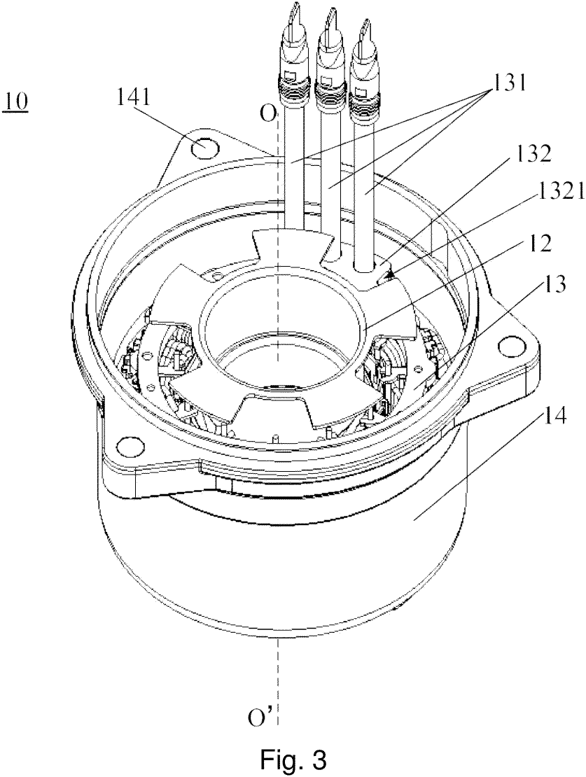

FIG. 1 is a schematic view of a motor according to the first example embodiment of the disclosure of the present application, and is a top view as viewed from one side in the axial direction. FIG. 2 is a perspective view illustrating a process of assembling the motor, and does not illustrate a rotor of the motor. FIG. 3 is a perspective view of the motor.

The motor 10 includes a stator 11, a rotor 12, a bus bar assembly 13, and a housing 14. The rotor 12 rotates relative to the stator 11 about a central axis OO' extending along the axial direction. The bus bar assembly 13 is provided on one side (O side) in the axial direction of the stator 11. The housing 14 accommodates the stator 11, the rotor 12, and the bus bar assembly 13. The housing 14 accommodates at least a part or all of each member of the stator 11, the rotor 12, and the bus bar assembly 13.

As illustrated in FIG. 1, the bus bar assembly 13 includes an interface portion 132 in which a power supply connection terminal 131 is disposed. The interface portion 132 is provided with a first positioning portion 1321 positioned by a positioning jig. The housing 14 is provided with a second positioning portion 141 positioned by a positioning jig. The first positioning portion 1321 and the second positioning portion 141 are positioned relative to each other at predetermined relative positions.

When the first positioning portion 1321 and the second positioning portion 141 are at predetermined relative positions, the relative position between the housing 14 and the bus bar assembly 13 is accurately positioned. Accordingly, the bus bar assembly 13 can be accurately positioned with respect to the housing 14. In particular, the interface portion 132 on which the power supply connection terminal 131 is disposed can be accurately positioned. Thus, the assembly accuracy of the motor 10 can be enhanced. Therefore, for example, when there is a demand for the positional accuracy of the power supply connection terminal 131 from a customer, the demand can be satisfied.

In the disclosure of the present application, the motor 10 may be of various types, and the type of the motor 10 is not limited. In addition to the stator 11, the rotor 12, the bus bar assembly 13, and the housing 14, the motor 10 may include other members such as bearings, for example, and the related art may be referred to.

The bus bar assembly 13 includes a metal bus bar and a resin bus bar holder that supports the bus bar. The bus bar has a bus bar terminal exposed from the bus bar holder. For example, the bus bar terminal includes an internal terminal for connecting to a member inside the motor such as a winding, and the power supply connection terminal 131 for connecting to an external power source. The bus bar holder includes an annular main body portion and an interface portion 132 that supports the power supply connection terminal 131. The main body portion has an annular shape. The internal terminal protrudes radially inward from the inner peripheral surface of the main body portion. As illustrated in FIGS. 1 to 3, the interface portion 132 is provided to protrude radially outward from the outer peripheral surface on the radially outer side of the main body portion. The power supply connection terminal 131 protrudes from the interface portion 132 toward the axial direction O. The interface portion 132 may be provided on the axial direction O side of the main body portion.

In the first example embodiment, the shapes of the first positioning portion 1321 and the second positioning portion 141 are not limited. For example, the first positioning portion 1321 or the second positioning portion 141 may be any one of a point, a hole, a line, a surface, and the like. The first positioning portion 1321 that can be used for positioning may be provided in the interface portion 132, and the second positioning portion 141 that can be used for positioning may be provided in the housing 14.

In the present example embodiment, a plurality of second positioning portions 141 are provided. The number of the second positioning portions 141 is selected on the basis of actual needs (for example, ease of measuring the relative position between the first positioning portion and the second positioning portion). In the present example embodiment, the first positioning portion 1321 and the second positioning portion 141 are at predetermined relative positions in a plurality of places. The predetermined distance between the first positioning portion 1321 and the second positioning portion 141 is, for example, an actual distance or a distance in a plane perpendicular to the axial direction when viewed from the axial direction. Regarding the predetermined angle between the first positioning portion 1321 and the second positioning portion 141, for example, when viewed from the axial direction, an included angle between a line connecting the first positioning portion 1321 and the central axis OO' of the motor and a line connecting the second positioning portion and the central axis OO' of the motor is a predetermined angle. However, the present disclosure is not limited thereto. For example, when the first positioning portion 1321 is a line or a plane, the included angle between the first positioning portion 1321 and the straight line connecting the second positioning portion and the central axis OO' of the motor may be a predetermined angle between the first positioning portion 1321 and the second positioning portion 141. The specific numerical values of the distance and the angle are set based on actual needs.

As illustrated in FIGS. 1 and 3, in the present example embodiment, the first positioning portion 1321 is a first positioning flat surface, that is, a flat surface used for positioning. The second positioning portion 141 is a positioning hole, that is, a hole used for positioning. The distance to the first positioning flat surface 1321 with respect to the second positioning portion 141 (positioning hole) is a predetermined size. In a plane perpendicular to the central axis OO', an included angle a between a straight line L1 connecting the second positioning portion 141 (positioning hole) and the central axis OO' and the first positioning flat surface 1321 is a first angle having a predetermined size. In the present example embodiment, the included angle a is larger than 45 degrees and smaller than 90 degrees. Here, a broken line S1 indicates a plane including the first positioning flat surface 1321.

Since the distance from the first positioning flat surface 1321 to the second positioning portion 141 (positioning hole) is a predetermined size, the interface portion 132 can be accurately positioned by the housing 14, assembly accuracy of the motor 10 can be improved, and customer requirements can be satisfied.

The direction of the first positioning flat surface 1321 may be any direction. For example, as illustrated in FIG. 1, the first positioning flat surface 1321 extends along the radial direction. That is, the central axis OO' is located in a plane including the first positioning flat surface 1321. The included angle a between the straight line L1 connecting the second positioning portion 141 (positioning hole) and the central axis OO' and the first positioning flat surface 1321 is a first angle having a predetermined size. However, the disclosure of the present application is not limited thereto. For example, the first positioning flat surface 1321 extends along another direction, and the central axis OO' may not be located in the first positioning flat surface 1321.

In the present example embodiment, as illustrated in FIGS. 1 and 2, the first positioning flat surface 1321 is a surface on one side in the circumferential direction of the interface portion 132, and a surface on the other side in the circumferential direction of the interface portion 132 is the second positioning flat surface 1322. That is, the first positioning flat surface 1321 and the second positioning flat surface 1322 are respectively provided on both sides of the interface portion 132 in the circumferential direction. Both the first positioning flat surface 1321 and the second positioning flat surface 1322 extend along the radial direction.

In the assembly process of the motor, when the relative position between the positioning jig and the housing 14 for contacting the first positioning flat surface 1321 is determined, the positioning jig contacts the second positioning flat surface 1322 to press the bus bar assembly 13 in the circumferential direction. Accordingly, the first positioning flat surface 1321 is brought into contact with the positioning jig, and the circumferential position of the bus bar assembly 13 can be accurately adjusted.

In the present example embodiment, as illustrated in FIG. 1, a positioning recess 111 is provided on the outer peripheral surface of the stator 11. An included angle b between a straight line L2 connecting the positioning recess 111 and the central axis OO' and the first positioning flat surface 1321 is within a predetermined range.

Accordingly, positioning between the stator 11 and the bus bar assembly 13 can be realized. First, the bus bar assembly 13 and the stator 11 are roughly positioned. Next, the bus bar assembly 13 and the housing 14 are accurately positioned. Since the included angle b can be adjusted within a predetermined range, accurate positioning between the bus bar assembly 13 and the housing 14 is hardly affected.

A specific numerical value of the included angle b of the disclosure of the present application is not limited to this, and is set based on actual needs. In the present example embodiment, the included angle b is smaller than the included angle a and smaller than 45 degrees.

In the present example embodiment, as illustrated in FIGS. 1 and 2, the bus bar holder has a foot portion 133 extending along the axial direction. The foot portion 133 is supported by a surface on one side (O side) in the axial direction of the stator 11. However, the foot portion 133 and the stator 11 do not interfere with each other in the circumferential direction. That is, the foot portion 133 contacts only the surface on one side in the axial direction of the stator 11 with respect to the stator 11. As a result, the circumferential position of the bus bar assembly 13 can be adjusted without interfering with the stator 11, and the positioning of the bus bar assembly 13 in the circumferential direction is facilitated.

The number of the foot portions 133 may be one or more. When there are a plurality of foot portions 133, the foot portions 133 may be arranged at equal intervals or unequal intervals in the circumferential direction, and may be supported on the surface on one side (O side) in the axial direction of the stator 11.

In the present example embodiment, as illustrated in FIGS. 2 and 3, the power supply connection terminal 131 extends along the axial direction. The length of the power supply connection terminal 131 is equal to or longer than the axial length of the housing 14. The length of the power supply connection terminal 131 is twice or more the axial length of the stator 11. According to the disclosure of the present application, the positional accuracy of the power supply connection terminal 131 can be guaranteed when the length of the power supply connection terminal 131 is within a predetermined range.

The power supply connection terminal 131 may extend along another direction such as the radial direction, for example. The length of the power supply connection terminal 131 may not have the above-described relationship with respect to the axial length of the housing or the axial length of the stator.

According to the first example embodiment of the disclosure of the present application, the first positioning portion 1321 and the second positioning portion 141 are at predetermined relative positions, and the relative position between the housing 14 and the bus bar assembly 13 can be accurately positioned. Therefore, the bus bar assembly 13 can be accurately positioned by the housing 14. In particular, the interface portion 132 on which the power supply connection terminal 131 is disposed can be accurately positioned, and assembly accuracy of the motor 10 can be improved. Therefore, for example, when there is a demand for the positional accuracy of the power supply connection terminal 131 from a customer, the demand can be satisfied.

A second example embodiment of the disclosure of the present application provides a positioning device. The positioning device can be used to assemble the motor. This motor has the same structure as the motor 10 described in the first example embodiment. In the first example embodiment, the structure of the motor 10 has been described in the first example embodiment, and the description thereof will be omitted in the second example embodiment.

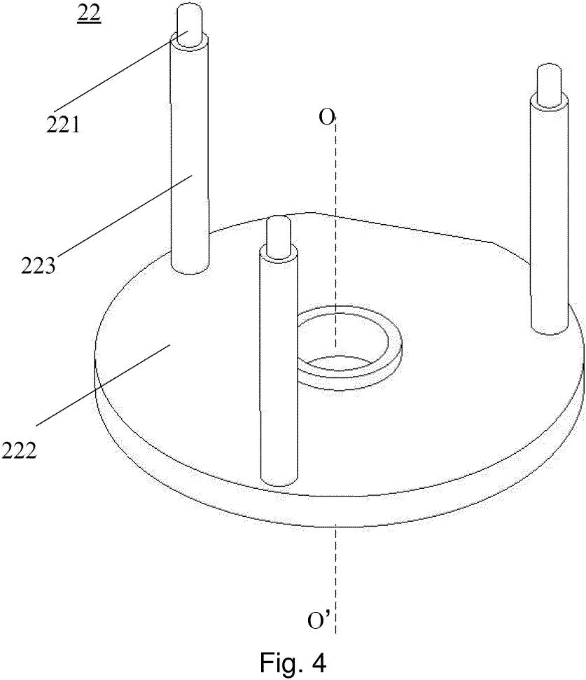

FIGS. 1 and 2 illustrate a positioning device of the disclosure of the present application. FIG. 4 is a schematic view of a second positioning jig.

As illustrated in FIGS. 1, 2, and 4, a positioning device 20 includes a first positioning jig 21 and a second positioning jig 22. The first positioning jig 21 includes a third positioning portion 211 that comes into contact with the first positioning portion 1321 of the bus bar assembly 13 of the motor 10.

The third positioning portion 211 and the second positioning jig 22 are positioned relative to each other at a predetermined relative position during positioning. As a result, the relative position between the bus bar assembly 13 and the housing 14 is accurately positioned. Therefore, the assembly accuracy of the motor 10 can be enhanced, and the quality of the motor 10 can be secured.

In the present example embodiment, the third positioning portion 211 comes into contact with the first positioning portion 1321 of the interface portion 132. Further, the second positioning jig 22 supports the second positioning portion 141 of the housing 14. Regarding the relative positions of the third positioning portion 211 and the second positioning jig 22, the description of the first example embodiment regarding the relative positions of the first positioning portion 1321 and the second positioning portion 141 can be referred to.

In the present example embodiment, as illustrated in FIGS. 1 and 4, the third positioning portion 211 is a surface. The second positioning jig 22 is a pin 221 extending along the axial direction. The pin 221 is inserted into the hole as the second positioning portion 141. The included angle between the straight line L1 connecting the pin 221 and the center (central axis OO') of the motor 10 and the third positioning portion 211 is a first angle having a predetermined size. That is, the included angle a between the straight line L1 connecting the second positioning portion 141 (hole) and the central axis OO' and the first positioning flat surface 1321 is the first angle having a predetermined size. As described above, the relative position between the bus bar assembly 13 and the housing 14 can be accurately positioned.

In the present example embodiment, as illustrated in FIGS. 2 and 4, the second positioning jig 22 includes a pedestal 222 and a plurality of columns 223 provided on the pedestal 222. An opening is provided at the center of the pedestal 222. The pin 221 is provided at one end of the column 223 on the axial direction O side, and extends from one end of the column 223 toward the axial direction O side. Accordingly, when the motor is assembled, the axial direction O′ side of the housing can be disposed in the central opening of the pedestal 222. The pin 221 and the second positioning portion 141 (hole) of each of the housings 14 are fitted to each other, and the position of the housing 14 can be fixed when the motor is assembled. However, the disclosure of the present application is not limited thereto. The second positioning jig 22 may include only the pin 221 extending along the axial direction in order to support the second positioning portion 141.

The second positioning portion 141 may be a surface of the housing 14. In this case, the positioning jig 22 is a member that comes into contact with the second positioning portion 141.

In the present example embodiment, as illustrated in FIGS. 1 and 2, the positioning device 20 further includes a third positioning jig 23. The third positioning jig 23 includes a fifth positioning portion 231 that comes into contact with a fourth positioning portion of the interface portion 132. The fourth positioning portion and the first positioning portion 1321 are provided on both sides of the interface portion 132 in the circumferential direction. The fifth positioning portion 231 is used to press the interface portion 132 toward the third positioning portion 211 to bring the third positioning portion 211 into contact with the first positioning portion 1321. By bringing the third positioning portion 211 into contact with the first positioning portion 1321, relative positioning of the bus bar assembly 13 with respect to the housing 14 and/or the stator 11 can be realized.

In the example embodiment of the disclosure of the present application, the fourth positioning portion may be the second positioning flat surface 1322 in the first example embodiment, but is not limited thereto. The fourth positioning portion may be a point, a line, or the like.

In the present example embodiment, as illustrated in FIGS. 1 and 2, the positioning device 20 further includes a fourth positioning jig 24. The fourth positioning jig 24 is in contact with the positioning recess 111 of the stator 11 and is not in contact with both sides of the positioning recess 111 in the circumferential direction. In the present example embodiment, the fourth positioning jig 24 is a rib fitted into the positioning recess 111. The positioning recess 111 is provided on the outer peripheral surface of the stator 11. The included angle between the straight line connecting the fourth positioning jig 24 and the center of the motor 10 and the third positioning portion 211 is a second angle having a predetermined size. The third positioning portion 211 is a flat surface. As described above, positioning between the stator 11 and the bus bar assembly 13 can be realized, and further, electrical connection between the bus bar and the winding can be realized. By inserting the fourth positioning jig 24 into the positioning recess 111, the stator 11 and the bus bar assembly 13 can be positioned, and the assembly can be performed more easily.

A specific numerical value of the second angle is not limited in the disclosure of the present application, and is selected according to actual needs. In the present example embodiment, the second angle is the same angle as the included angle b and is less than 45 degrees.

The first positioning jig 21 and the fourth positioning jig 24 are integrated. That is, the first positioning jig 21 and the fourth positioning jig 24 are formed using the same member. This makes it easy to ensure the positioning accuracy of the positioning jig. However, the disclosure of the present application is not limited thereto, and the first positioning jig 21 and the fourth positioning jig 24 may be separate bodies.

According to the second example embodiment, the third positioning portion 211 and the second positioning jig 22 are at predetermined relative positions during positioning, and the relative position between the bus bar assembly 13 and the housing 14 is accurately positioned. As a result, the assembly accuracy of the motor 10 can be enhanced, and the quality of the motor 10 can be secured.

A third example embodiment provides a positioning method for positioning the motor 10 using the positioning device 20 of the second example embodiment in the assembly of the motor 10 of the first example embodiment. Regarding the structures of the motor 10 and the positioning device 20, the first example embodiment and the second example embodiment will be referred to, and the description thereof will be omitted.

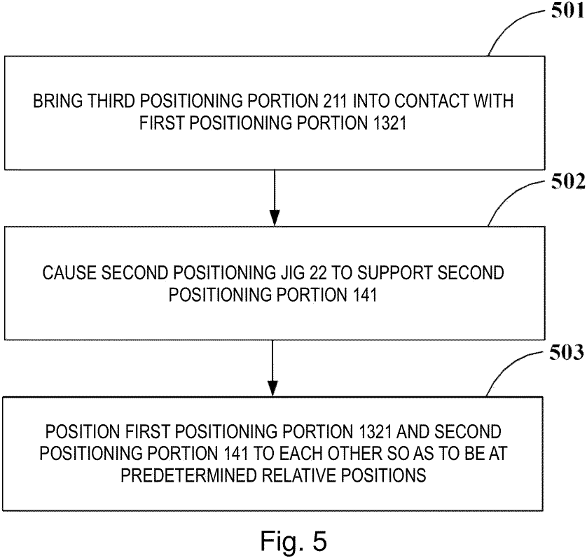

FIG. 5 is a flowchart of a positioning method according to a third example embodiment. The positioning method of the present example embodiment includes the following Steps 501, 502, and 503.

First, in Step 501, the third positioning portion 211 of the first positioning jig 21 is brought into contact with the first positioning portion 1321 of the bus bar assembly 13 of the motor 10. Next, in Step 502, the second positioning jig 22 is caused to support the second positioning portion 141 provided in the housing 14 of the motor 10. Next, in Step 503, the first positioning portion 1321 and the second positioning portion 141 are positioned to each other so as to be at predetermined relative positions. In the present example embodiment, the fourth positioning portion is provided in the interface portion 132, and the fourth positioning portion and the first positioning portion 1321 are provided on both sides of the interface portion 132 in the circumferential direction.

In Step 501, the fifth positioning portion 231 of the third positioning jig 23 is brought into contact with the fourth positioning portion of the interface portion 132, and the interface portion 132 is pressed toward the first positioning jig 21. Accordingly, the first positioning jig 21 is brought into contact with the first positioning portion 1321.

When the third positioning portion 211 and the second positioning jig 22 are at predetermined relative positions, the third positioning jig 23 presses the bus bar assembly 13 in the circumferential direction to adjust the circumferential position of the bus bar assembly 13. By bringing the first positioning portion 1321 into contact with the third positioning portion 211, the first positioning portion 1321 and the second positioning portion 141 can be adjusted to be at predetermined relative positions.

The bus bar assembly 13 is disposed on one side (O side) in the axial direction of the stator 11, and the fourth positioning jig 24 is brought into contact with the positioning recess 111 on the outer periphery of the stator 11. Here, the fourth positioning jig 24 is not brought into contact with both sides of the positioning recess 111 in the circumferential direction. The included angle between the straight line connecting the fourth positioning jig 24 and the central axis OO' and the third positioning portion 211 is the second angle having a predetermined size. The third positioning portion 211 is a flat surface, and the description in the second example embodiment can be referred to. As described above, mutual positioning between the stator 11 and the bus bar assembly 13 can be realized.

The execution order of each step in the method described above can be changed. For example, Step 502 may be performed first, followed by Step 501. In the method described above, other steps of assembling the motor 10 may be included. For this other step, reference may be made to the related art, and description thereof is omitted herein.

According to the positioning method of the third example embodiment, the first positioning portion 1321 and the second positioning portion 141 can be positioned relative to each other at a predetermined relative position during assembly of the motor. As a result, the relative position between the housing 14 and the bus bar assembly 13 can be accurately positioned, and the bus bar assembly 13 can be accurately positioned by the housing 14. In particular, the interface portion 132 on which the power supply connection terminal 131 is disposed can be accurately positioned, and assembly accuracy of the motor 10 can be improved. Therefore, for example, when there is a demand for the positional accuracy of the power supply connection terminal 131 from a customer, the demand can be satisfied.

Although the disclosure of the present application has been described above with reference to specific example embodiments, these descriptions are all exemplary and not restrictive of the protection scope of the disclosure of the present application. Those skilled in the art can make various modifications and corrections to the disclosure of the present application based on the gist and principle of the disclosure of the present application, and these modifications and corrections are also within the scope of the disclosure of the present application.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a stator;
a rotor rotatable relative to the stator about a central axis extending along an axial direction;
a bus bar assembly on one side of the stator in the axial direction; and
a housing that accommodates the stator, the rotor, and the bus bar assembly; wherein
the bus bar assembly includes an interface portion in which a power supply connection terminal is provided;
the interface portion includes a first positioning portion to position the bus bar assembly;
the housing includes a second positioning portion to position the housing; and
first positioning portion and the second positioning portion are positioned relative to each other by being respectively provided in predetermined relative positions.

2. The motor according to claim 1, wherein
the first positioning portion includes a first positioning flat surface;
the second positioning portion includes a positioning hole; and
a distance from the first positioning flat surface to the positioning hole is a predetermined size.

3. The motor according to claim 2, wherein
the first positioning flat surface extends along a radial direction; and
an included angle between a line connecting the positioning hole and the central axis and the first positioning flat surface is a first angle having a predetermined size.

4. The motor according to claim 2, wherein
the first positioning flat surface is a surface on one side in a circumferential direction of the interface portion;
a surface on another side in the circumferential direction of the interface portion is a second positioning flat surface; and
both the first positioning flat surface and the second positioning flat surface extend along a radial direction.

5. The motor according to claim 2, wherein
a positioning recess is on an outer peripheral surface of the stator; and
an included angle between a straight line connecting the positioning recess and the central axis and the first positioning flat surface is within a predetermined range.

6. The motor according to claim 1, wherein
the bus bar assembly includes a foot portion extending along the axial direction;
the foot portion is supported by a surface on the one side of the stator in the axial direction; and
the foot portion and the stator do not interfere with or contact each other in a circumferential direction.

7. The motor according to claim 1, wherein
the power supply connection terminal extends along the axial direction;
a length of the power supply connection terminal is longer than an axial length of the housing or equal to the axial length of the housing; and
a length of the power supply connection terminal is two times or more greater than an axial length of the stator.

8. A positioning device used to assemble a motor, the positioning device comprising:
a first positioning jig; and
a second positioning jig; wherein
the motor includes:
a stator;
a rotor rotatable relative to the stator about a central axis extending along an axial direction;
a bus bar assembly on one side of the stator in the axial direction; and
a housing that accommodates the stator, the rotor, and the bus bar assembly;
the bus bar assembly includes an interface portion in which a power supply connection terminal is provided;
the interface portion includes a first positioning portion to position the bus bar assembly;
the housing includes a second positioning portion to position the housing;
the first positioning jig includes a third positioning portion to make contact with the first positioning portion of the bus bar assembly, and to support the second positioning portion; and
the third positioning portion and the second positioning jig are located at predetermined relative positions with respect to each other during positioning.

9. The positioning device according to claim 8, wherein
the third positioning portion includes a surface;
the second positioning jig includes a pin extending along the axial direction;
the second positioning portion includes a hole; and
an included angle between a straight line connecting the pin and the central axis and the third positioning portion is a first angle having a predetermined size.

10. The positioning device according to claim 9, further comprising:
a third positioning jig; wherein
the interface portion includes a fourth positioning portion;
the third positioning jig includes a fifth positioning portion that comes into contact with the fourth positioning portion;
the fourth positioning portion and the first positioning portion are provided on two sides of the interface portion in a circumferential direction; and
the fifth positioning portion presses the interface portion of the bus bar assembly toward the third positioning portion to bring the third positioning portion into contact with the first positioning portion.

11. The positioning device according to claim 8, further comprising:
a fourth positioning jig; wherein
a positioning recess is on an outer peripheral surface of the stator;
the fourth positioning jig is in contact with the positioning recess and is not in contact with two sides of the positioning recess in a circumferential direction;
an included angle between a straight line connecting the fourth positioning jig and the central axis and the third positioning portion is a second angle having a predetermined size; and
the third positioning portion includes a flat surface.

12. The positioning device according to claim 11, wherein the first positioning jig and the fourth positioning jig are defined by a same structure.

13. A positioning method for positioning a motor by a positioning jig, wherein
the motor includes:
a stator;
a rotor rotatable relative to the stator about a central axis extending along an axial direction;
a bus bar assembly on one side of the stator in the axial direction; and
a housing that accommodates the stator, the rotor, and the bus bar assembly;
the bus bar assembly includes an interface portion in which a power supply connection terminal is provided;
the interface portion includes a first positioning portion to position the bus bar assembly;
the housing includes a second positioning portion to position the housing;
the positioning jig includes a first positioning jig and a second positioning jig; and
the first positioning jig includes a third positioning portion;
the method comprising:
bringing the third positioning portion into contact with the first positioning portion of the interface portion;
supporting the second positioning portion with a second positioning jig; and
positioning the first positioning portion and the second positioning portion at predetermined relative positions.

14. The positioning method according to claim 13, wherein
the interface portion includes a fourth positioning portion;
the fourth positioning portion and the first positioning portion are on two sides of the interface portion in a circumferential direction;
the positioning jig includes a third positioning jig;
the third positioning jig includes a fifth positioning portion; and
the third positioning portion includes a flat surface;
the method further includes:
bringing the first positioning jig into contact with the first positioning portion;
bringing the fifth positioning portion into contact with the fourth positioning portion of the interface portion and pressing the interface portion toward the first positioning jig; and
bringing the first positioning jig into contact with the first positioning portion.

15. The positioning method according to claim 13, wherein
the positioning jig includes a fourth positioning jig;
a positioning recess is on an outer peripheral surface of the stator; and
an included angle between a straight line connecting the fourth positioning jig and the central axis and the third positioning portion is a second angle having a predetermined size;
the method further includes:
arranging the bus bar assembly on one side of the stator of the motor in the axial direction; and
bringing the fourth positioning jig into contact with the positioning recess without bringing the fourth positioning jig into contact with two sides of the positioning recess in a circumferential direction.
